(19) United States
(12) Patent Application Publication
(10) Pub. No.: US 2007/0037513 A1
(43) Pub. Date: Feb. 15, 2007

(54) System and method for targeted message delivery and subscription

(75) Inventors: Rachel K. Bellamy, Bedford, NY (US); Peter K. Malkin, Ardsley, NY (US); John T. Richards, Chappaqua, NY (US); Justin D. Weisz, Stamford, CT (US); Tracee L. Wolf, Ossining, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/203,774

(22) Filed: Aug. 15, 2005

(51) Int. Cl. H04H 1/00; H04B 1/38

(52) U.S. Cl. 455/3.04; 455/566

(57) ABSTRACT

A system, method and computer program product for product that enables users of broadcast messaging systems to more expediently and efficiently find communities, both for subscribing and for sending messages. The system, method and computer program product provides an end-user with the ability to send messages for delivery to more targeted communities of messaging users. In this aspect, the system and method determines one or more attributes of messaging activity associated with one or more communities of users communicating messages in a messaging system; and, displays via an interface, a graphical representation of the attributes and inter-relationships between the attributes. The user may then select via the interface a recipient community for receiving a message to be sent based on the graphical representation displayed.

### BACKGROUND OF THE INVENTION

1. Field of the Invention

The present invention relates generally to the field of message broadcasting systems, such as collaborative messaging systems, and, more particularly, to a novel system and method for adapted to provide users with a graphical representation of information about messaging communities to enable users to subscribe to or provide communities with more targeted message delivery.

2. Discussion of the Prior Art

Collaborative computing provides a means for users to pool their strengths and experiences to achieve a common goal. For example, a common goal may be an educational objective, the completion of a software development project or even creation and use of a system to manage human resources. The establishment of a collaborative computing environment typically involves the creation or definition of a community. The community provides the framework under which a collaborative computing objective is achieved.

In collaborative messaging systems, messages are not sent to specific people, or groups of people, but rather are sent to categories descriptive of the message content. Typically, this set of categories is presented as a list, with very little additional information beyond the name of the category and perhaps a short description. If the list of categories is very long, it can be difficult for a user to choose an appropriate category or categories for a new message desired to be sent. Providing a list of categories is also typically the means by which users choose which messages they want to receive; they can choose to ‘subscribe’ to particular categories.

International Business Machines Corporation (IBM), the current assignee of the present invention, provides to its employees worldwide asynchronous broadcasting system comprising tools providing a suite of messaging services designed to support informal communications among employees. The primary function of these tools is to allow employees to send broadcast messages to other users of the messaging tools, and receive a response back in real-time, by way of instant messaging. When a broadcast message is received, it is displayed to the user in the form of an alert, for example, in the form of a sliding window in their interface display screen. The position and duration of the alert is configurable by the user, and the user can also configure an audible alert when a broadcast is received.

Because sending broadcast messages has the potential to reach thousands of people, some care needs to be taken in targeting these messages to an appropriate subset of people. The suite of tools helps users reach a relevant set of people by requiring senders to direct their messages to a chosen “community”, and receivers can choose which communities to subscribe to. There is also one special community, known as the ‘everyone’ community. Messages sent to the ‘everyone’ community typically reach several thousand users around the world.

FIGS. 3A and 3B depict a current user interface for the current IBM suite of broadcast messaging tools. As shown in FIG. 3A, the screen 30 displays a list of all of the “communities” 35 when a user first accesses the tools. This list includes up to 1000 items, making it a very tedious process for a user to scroll through and find the communities he/she is interested in. Fortunately, there is a field to type in one or more keywords to do a search. However, searching provides a limited set of results and is only as good as the terms a person can think of as being relevant.

When a user desires to send a broadcast message, the interface 40 depicted in FIG. 3B is provided that displays a list of all of the communities 45 the particular user is subscribed to. Consequently, users that are subscribed to every community will display a lot of items for the user. In operation, the user chooses the community to send to, and then selects one of a series of buttons, e.g., icons 47, representing the type of broadcast desired to be sent.

It would be highly desirable to provide a system and method that makes it easier for end-users to find communities to send their messages to. Such a method could also be used to help people decide which communities to subscribe to.

Thus, it would be highly desirable to provide a novel broadcasting system and method that enables users to provide for more targeted message delivery.

### SUMMARY OF THE INVENTION

It is an object of the present invention to provide a comprehensive system, method and computer program product that enables users of broadcast messaging systems to more expediently and efficiently find communities, both for subscribing to receive and for sending messages.

Preferably, the invention provides for a more targeted message delivery system by enabling the display of more information about the communities, and what's going on inside them such that, users of the system will have enough information to make a better decision as to what community they desire to send their message to, and which communities to subscribe to.

Thus, there is provided a system, method and computer program product that enables users of broadcast messaging systems to more expediently and efficiently find communities, both for subscribing to receive and for sending messages. The system, method and computer program product provides an end-user with the ability to send messages for delivery to more targeted communities of messaging users.

In this aspect, there is provided a method for targeting message delivery comprising: determining one or more attributes of messaging activity associated with one or more communities of users communicating in a messaging system; displaying via an interface, a graphical representation of the attributes and inter-relationships between the attributes; and, enabling a user to select via the interface a recipient community for receiving a message to be sent based on the graphical representation displayed.

According to a further aspect of the invention there is provided a system for targeting message delivery in a messaging system comprising: means for monitoring attributes of messages associated with one or more communities of users communicating in a messaging system; means for dynamically representing the attributes and their inter-relationships via interface devices for an end-user; and, means enabling an end-user to make a selection of a community based on the dynamic representation.

Advantageously, the system and method of the invention can be used to solve the problem of selection of categories in information systems that have multiple attributes such as: content management system, knowledge management systems, and Really Simple Syndication (RSS) feeds.

### BRIEF DESCRIPTION OF THE DRAWINGS

The objects, features and advantages of the present invention will become apparent to one skilled in the art, in view of the following detailed description taken in combination with the attached drawings, in which:

FIG. 1 is an exemplary block diagram of a distributed data processing system in which the present invention may be implemented;

FIG. 2 depicts an example computer system architecture 100 in which the system and method of the invention is implemented;

FIGS. 3A and 3B depict a current user interface for a current suite of broadcast messaging tools provided by IBM;

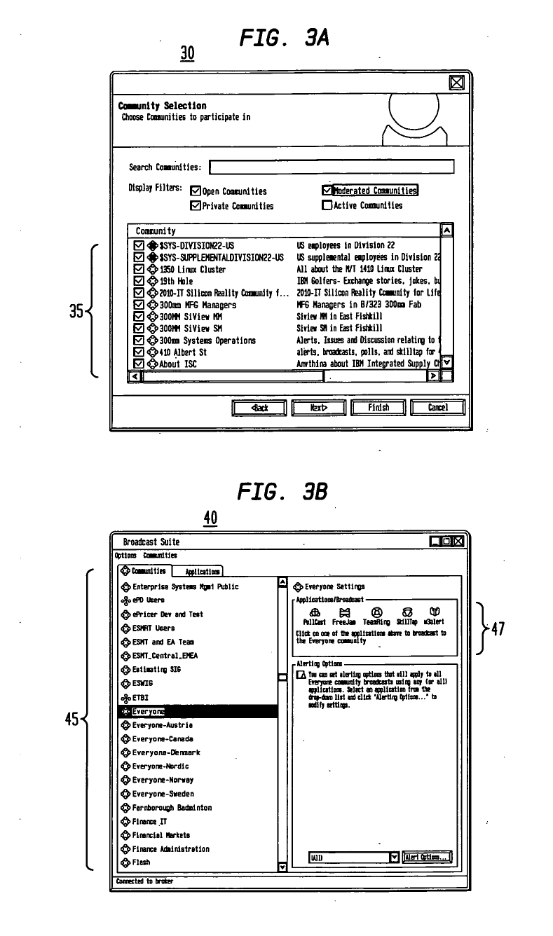

FIG. 4 depicts an example interface 200 generated in accordance with the principles of the invention that presents a visualization of ICT (messaging) communities enabling more targeted message delivery according to the invention;

FIGS. 5A and 5B depict example displays presenting the community relationships that are stronger than 15% similarity and 55% similarity, respectively, as a result of manipulating a strength similarity filter implemented in the system of the present invention; and,

FIG. 6 depicts a novel interface 300 showing two information windows or displays presented when the user interacts with the interface according to the invention.

### DETAILED DESCRIPTION OF PREFERRED EMBODIMENT

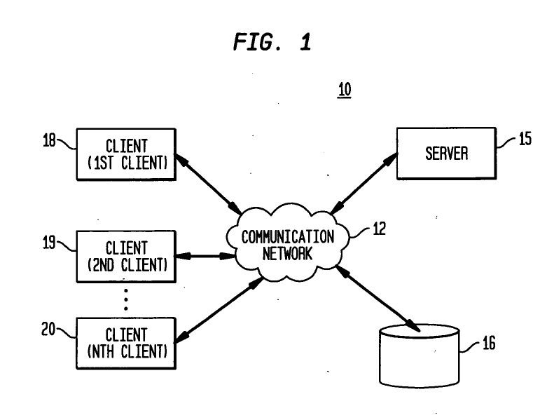

The present invention is directed to improving communications in a network of peers, such as in a distributed data processing system illustrated in FIG. 1.

FIG. 1 depicts a representation of a network of data processing systems in which the present invention may be implemented. Network data processing system 10 includes a network 12, which is the medium used to provide communications links between various devices and computers connected together within data processing system 10. Network 12 may include connections, such as wire, wireless communication links, or fiber optic cables. In the depicted example, server 15 is connected to network 12 along with storage unit 16. In addition, clients 18-20, for example, personal computers or network computers, are connected to network 12. In the depicted example, server 15 provides data, such as boot files, operating system images, and applications to clients 18-20. Clients 18-20 are clients to server 104. Network data processing system 10 may include additional servers, clients, and other devices not shown. In the depicted example, network data processing system 10 is the Internet with network 12 representing a worldwide collection of networks and gateways that use the Transmission Control Protocol/Internet Protocol (TCP/IP) suite of protocols to communicate with one another. At the heart of the Internet is a backbone (not shown) comprising high-speed data communication lines between major nodes, host computers, and thousands of other computer systems that route data and messages. It is understood that network data processing system 10 also may be implemented as a number of different types of networks, such as for example, an intranet, a local area network (LAN), or a wide area network (WAN). FIG. 1 is intended as an example, and not as an architectural limitation for the present invention.

In a network of communicating peers, users may communicate with each other via their client devices, and also may make use of the aid of services offered via one or more server computing devices. Through such a network of communicating peers, users may send messages to one another, media files, and the like.

One exemplary communication network, serving as the basis for the description of the present invention, makes use of the “IBM Community Tools with Broadcast Suite” (hereafter referred to as ICT) tool. ICT allows users to communicate with each other, along the lines of instant messaging, to obtain feedback on various topics. Via this network configuration, communication among clients is logically peer-to-peer because each client can interact with other clients without moderation or explicit authorization. While ICT will be used as the basis for the present description of the preferred embodiments of the present invention, it should be appreciated that the mechanisms and functions of the present invention are not limited to ICT and may be used with any network that allows for a one-to-many type of communication.

The ICT is a suite of applications for interacting with various communities through instant and broadcast messaging. The power of client-side-filtered broadcast messaging is exploited to allow users to locate subject matter experts, start impromptu discussions, and alert and survey large groups of people instantly, all in real time. The Broadcast Suite of ICT allows users to use publish-subscribe technology to send messages to a large group of users in a community. With Broadcast Suite, a suite of applications allows for various types of communications between users of a community. These applications include Freejam, SkillTap, PollCast, TeamRing, and w3alert. For instance, as will be discussed in greater detail herein, Freejam allows a user to instantly initiate a just-in-time chat room for discussion of any topic. The chat room lasts for as long as the discussion continues and is abolished once the discussion ceases.

More information about ICT and Broadcast Suite is available from http://community.ngi.ibm.com/index.html. In addition, some aspects of the ICT and Broadcast Suite are described in co-pending and commonly assigned U.S. patent application Ser. No. 10/670,138 entitled “Method and apparatus for scalable peer-to-peer inquiries in a network of untrusted parties”, filed on Sep. 24, 2003 (now U.S Patent Pub. No. 2005/0065632, and hereby incorporated by reference.

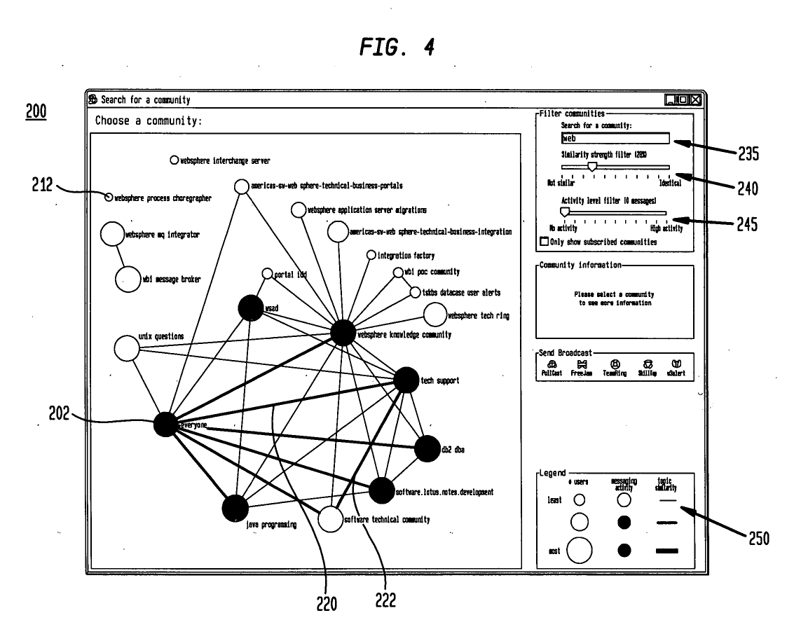

FIG. 4 depicts a novel interface 200 according to one aspect of the invention that displays information about the communities, and what's going on inside them, to give people enough information to make a better decision as to what community they send their message to, and which communities to subscribe to.

Particularly the interface 200 provided in FIG. 4 presents a visualization of ICT communities. In this example case, a user has entered a keyword search term “web” in a keyword filter entry field 235. In response, the system of the invention generates a display showing only a subset of the communities in ICT that are related to the “web” in some way. The circles in this picture represent the communities, and the size of the circles show the number of users seen participating in those communities. It should be understood that the time frame of the display can be manipulated by the user in accordance with that user's interest. For example, the display can show recent history, current activity, or even activity since the inception of the community. This number is an approximation to the number of people subscribed to the community; and may be obtained by counting the number of unique users seen sending a message or joining a FreeJam (for example), for each community. As shown in the example interface depicted in FIG. 4, the color of the circles represents how much messaging activity has been taking place in the community. So, darker circles (like the ‘everyone’ community), such as circle 202, have received a lot of broadcast messages, whereas light circles, such as circle 212, have received very few messages. Furthermore, as depicted in the interface 200 provided in FIG. 4, the lines, e.g., 220, 222, etc., connecting the communities represent a similarity between communities. In the example embodiment depicted, the darker, thicker lines represent more similar communities. The legend 250 generated for display in the interface 200, provides a guide for interpreting the relationships shown in the display.

Thus, according to the visualization provided in interface 200 as shown in FIG. 4, many interdependencies, i.e., relationships, between communities are discoverable.

To determine the relationships between and among communities for visualization, a calculation is performed. In one embodiment, all the topics sent to a community may be accessed, and processed for determining similarities. For example, doing a similarity computation (cosine similarity with term frequencies) between all of the words in those topics will result in a similarity measure between the communities. One such similarity algorithm would analyze the content of the messages and determine the extent to which communities are similar by virtue of the use of the same keywords. Other similarity algorithms with greater or lesser degrees of precision might also be applicable. Displaying these similarities enables users to find topics of interest across communities (or emerging communities and trends), or find communities which should be merged (because they're talking about the same things), or even see collective experience among communities.

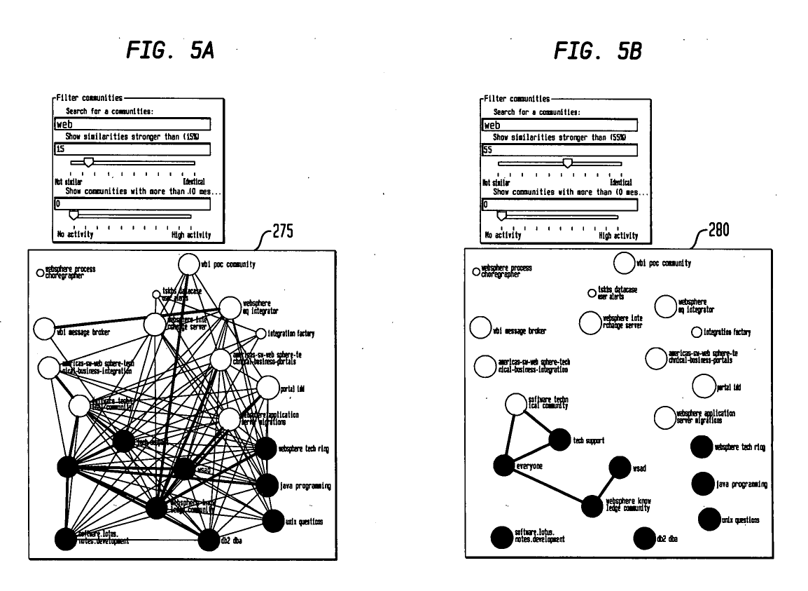

Further to the embodiment depicted in FIG. 4, in order to reduce the amount of information being displayed, the interface provides a filter function that enables manipulation of the set of communities that are displayed. For instance, as shown in FIG. 4, a first filter of the system includes the keyword filter 235 which enables users to search for community names, descriptions, or possibly popular topics within each community by specifying keywords. In the example display depicted in FIGS. 5A and 5B, a user has initiated a community search using the keyword “web”. As further shown in FIG. 4, a second similarity strength filter 240 comprising is provided 240 processes data for determining community similarities. Referring to FIG. 5A, in a first example, a user has manipulated the similarity filter 240 to show the relationships that are stronger than 15% similarity and in the resulting example display 275 depicted in FIG. 5A presents the community relationships that are stronger than 15% similarity. Since the display in FIG. 5A may not be useful to some users, the similarity filter 240 may be manipulated to show the relationships that are stronger than 55% similarity. In the example depicted in FIG. 5B, a resulting display 280 presents the community relationships that are stronger than 55% similarity. The display of FIG. 5B thus lets users easily see the stronger relationships.

A user can additionally filter out communities based on the number of broadcast messages sent to them. Referring back to FIG. 4, a third filter 245 manipulable by a user is provided to filter out communities based on the number of broadcast messages sent to them. Thus, if a user is only looking to send a message to an active community, that user can omit of all of the inactive communities using this filter.

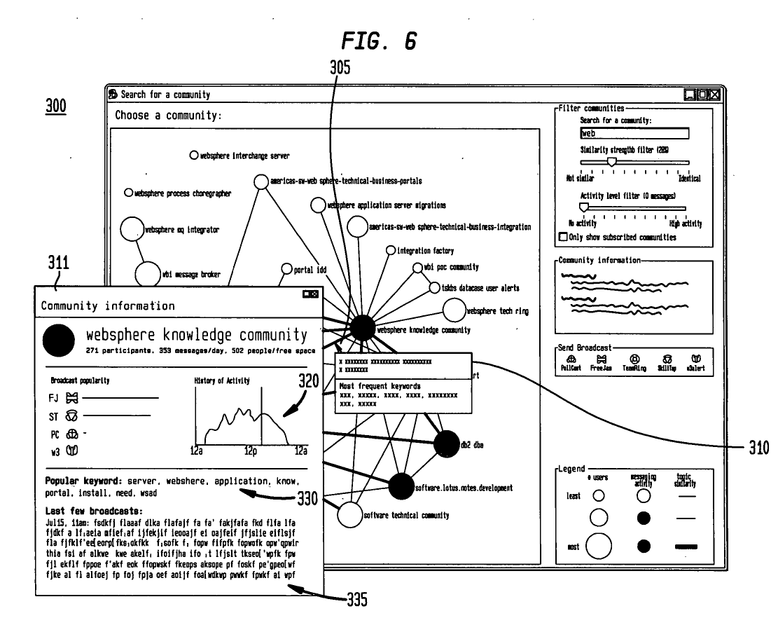

FIG. 6 depicts a novel interface 300 showing two information windows or displays 310, 311 when the user interacts with the interface. As shown in FIG. 6, as a result of user manipulating a pointer or cursor 305 via a mouse device, a first display 310 is generated for presentation when the user places the mouse cursor over a line linking two nodes (communities) in the display. The first display 310 provides information such as the most frequent keywords occurring in both communities. This is achieved via a similarity algorithm that can analyze the keywords used in each community and determine the extent to which other communities use similar keywords. This functionality is provided to enable users to determine exactly why two communities are related, and gives the user a sense of the kinds of messages sent to both communities.

The second information window 311 shows extended information about a community, including, but not limited to, the following information: the number of participants, the number of messages sent per day, and the average number of people who join a FreeJam, for example, as provided by the ICT tool. This information is useful for determining how active a community is, and how large of a response to expect when sending a broadcast message. Additionally included is a histogram 320 illustrating the popularity of each type of broadcast message, as well as a graph of the historical activity of the community over the course of a time interval, e.g., a day. Since ICT broadcasts are highly synchronous, this is useful for timing messages to a particular community. For example, if a user wants to send a message at 1:00 pm, and notices that not many messages are sent during this time, they may infer that 3:00 pm is a better time for the community to receive the message. Other information provided via second information window 311 includes popular keywords 330, as well as the last four broadcasts 335 sent to this community. Both of these give the user a sense of what kinds of messages are sent to the community.

The system, method, and computer program product of the present invention is thus designed to give the user important information regarding how a community is used, how often it is used, and what it is used for, so that the user can make an informed choice about where to send their broadcast message. The interface of FIGS. 4-6 gives users the information they need to make a good decision as to which communities they should subscribe and broadcast. The information windows 310, 311 of FIG. 6 facilitate comparing two (or more) communities, since there are a lot of similar communities having same or similar subject matter. The visualizations provided by the present invention enables users to further figure out where interest areas are, can be used to eliminate some of the redundancy in the community list.

Ultimately, the usage of the ‘everyone’ community would be significantly reduced, and the usage of other, more focused communities would increase.

As further mentioned herein, the system and method of the invention can be used to solve the problem of selection of categories in information systems that have multiple attributes such as: content management system, knowledge management systems, and Really Simple Syndication (RSS) feeds. For example, RSS feeds contain a description tag. Analysis of description tags across feeds could be used to produce a topic similarity metric that could be graphed in the same way that topic similarity was graphed in the messaging system. RSS feed lists might likewise become too long or their descriptions and titles too vague to ascertain their relevance as to what a user is interested in. A graphical representation of the feed attributes and the use-metrics would give the user insight to the content and general use of the feeds so that the user could decide which RSS feed has the most relevant information to them at that time. For example RSS feeds contain a description tag. Analysis of description tags across feeds could be used to produce a topic similarity metric that could be graphed in the same way that topic similarity is graphed in the messaging system. Another tag in the RSS feed is pubDate. This date information could also be added as visual attributes to the graph, thus allowing the graph to represent in a single picture multiple attributes specified in the feed. Furthermore, the feed generator could collect data about feed subscription, such as how many people have subscribed, when the first person subscribed and when the last person to subscribe subscribed. This additional usage information may then be added to the graphical representation. Such a graphical representation of the feed attributes and the use-metrics would help the user select which RSS feed to subscribe to.

As will be appreciated by one of skill in the art, embodiments of the present invention may be provided as methods, systems, or computer program products. Accordingly, the present invention may take the form of an entirely software embodiment or an embodiment combining software and hardware aspects. Furthermore, the present invention may take the form of a computer program product, which is embodied on one or more computer-usable storage media (including, but not limited to, disk storage, CD-ROM, optical storage, and so forth) having computer-usable program code embodied therein.

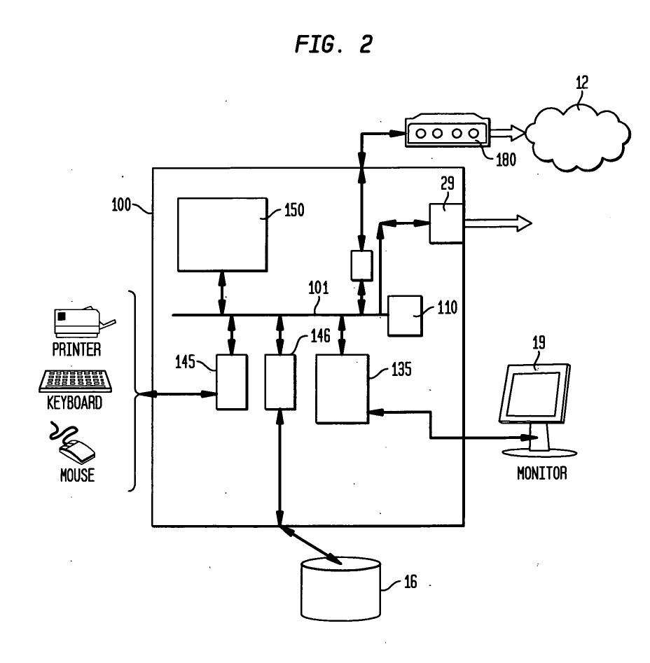

As shown in FIG. 2, the system for implementing the present invention may be provided in a computing device, e.g., desktop, mobile, including one or more processors or processing units 110, a system memory 150, and a bus 101 that connects various system components together. For instance, the bus 101 connects the processor 110 to the system memory 150. The bus 101 can be implemented using any kind of bus structure or combination of bus structures, including a memory bus or memory controller, a peripheral bus, an accelerated graphics port, and a processor or local bus using any of a variety of bus architectures such as ISA bus, an Enhanced ISA (EISA) bus, and a Peripheral Component Interconnects (PCI) bus or like bus device. Additionally, the computer system 100 includes one or more monitors 19 and, operator input devices such as a keyboard, and a pointing device (e.g., a “mouse”) for entering commands and information into computer, data storage devices, and implements an operating system such as Linux, various Unix, Macintosh, MS Windows OS, or others.

The computing system 100 additionally includes: computer readable media, including a variety of types of volatile and non-volatile media, each of which can be removable or non-removable. For example, system memory 150 includes computer readable media in the form of volatile memory, such as random access memory (RAM), and non-volatile memory, such as read only memory (ROM). The ROM may include an input/output system (BIOS) that contains the basic routines that help to transfer information between elements within computer device 100, such as during start-up. The RAM component typically contains data and/or program modules in a form that can be quickly accessed by processing unit. Other kinds of computer readable media 105 for storing program data and/or audio data to be segmented according to the invention include a hard disk drive (not shown) for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. Any data storage media 105 including hard disk drive, magnetic disk drive, and optical disk drive would be connected to the system bus 101 by one or more data media interfaces 146. Alternatively, the hard disk drive, magnetic disk drive, and optical disk drive can be connected to the system bus 101 by a SCSI interface (not shown), or other coupling mechanism. Although not shown, the computer 100 can include other types of computer readable media. Generally, the above-identified computer readable media provide non-volatile storage of computer readable instructions, data structures, program modules, and other data for use by computer 100. For instance, the readable media can store the operating system (O/S), one or more application programs, such as the messaging system software (IBM's ICT) or other collaborative messaging applications, and/or other program modules and program data providing a collaborative environment according to the invention. Input/output interfaces 145, 146 are provided that couple the input devices and data storage devices to the processing unit 110. More generally, input devices can be coupled to the computer 100 through any kind of interface and bus structures, such as a parallel port, serial port, universal serial bus (USB) port, etc. The computer environment 100 also includes the display device 19 and a video adapter card 135 that couples the display device 19 to the bus 101. In addition to the display device 19, the computer environment 100 can include other output peripheral devices, such as speakers (not shown), a printer, etc. I/O interfaces 145 are used to couple these other output devices to the computer 100.

Computing system 100 is further adapted to operate in a networked environment using logical connections to one or more other computers such as server device 15 (FIG. 1), that may include all of the features discussed above with respect to computer device 100, or some subset thereof. It is understood that any type of network can be used to couple the computer system 100 with server device 15, such as a local area network (LAN), or a wide area network (WAN) 300 (such as the Internet). When implemented in a LAN networking environment, the computer 100 connects to a local network via a network interface or adapter 29, e.g., supporting Ethernet or like network communications protocols. When implemented in a wide area network (WAN) networking environment, the computer 100 may connect to a WAN 300 via a high speed cable/DSL modem 180 or some other connection means. The cable/DSL modem 180 can be located internal or external to computer 100, and can be connected to the bus 101 via the I/O interfaces 145 or other appropriate coupling mechanism. Although not illustrated, the computing environment 100 can provide wireless communication functionality for connecting computer 100 with other networked remote devices (e.g., via modulated radio signals, modulated infrared signals, etc.).

In the networked environment, it is understood that the computer system 100 can draw from program modules stored in remote memory storage devices (not shown) in a distributed configuration. However, wherever physically stored, one or more of the application programs executing the targeted messaging system of the invention can include various modules for performing principal tasks. For instance, the application program can implement logic enabling input of the community data for storage in a centralized data storage system and/or logic for performing the targeted messaging techniques thereon. Other program modules can be used to implement additional functionality not specifically identified here.

The present invention has been described with reference to diagrams of methods, apparatus (systems) and computer program products according to embodiments of the invention. It will be understood that each diagram, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified herein.

These computer program instructions may also be stored in a computer-readable memory that can direct a computer or other programmable data processing apparatus to function in a particular manner, such that the instructions stored in the computer-readable memory produce an article of manufacture including instruction means which implement the function specified herein.

The computer program instructions may also be loaded onto a computer-readable or other programmable data processing apparatus to cause a series of operational steps to be performed on the computer or other programmable apparatus to produce a computer implemented process such that the instructions which execute on the computer or other programmable apparatus provide steps for implementing the functions specified herein.

While the invention has been particularly shown and described with regard to a preferred embodiment thereof, it will be understood by those skilled in the art that the foregoing and other changes in form and details may be made therein without departing from the spirit and scope of the invention.

Having thus described our invention, what we claim as new, and desire to secure by Letters Patent is:

1. A method for targeting message delivery comprising:
determining one or more attributes of messaging activity associated with one or more communities of users communicating in a messaging system;
displaying via an interface, a graphical representation of said attributes and inter-relationships between said attributes; and,
enabling a user to select via said interface a recipient community for receiving a message to be sent based on said graphical representation displayed.

2. The method for targeting message delivery as claimed in claim 1, wherein determining one or more attributes comprises: accessing message topics sent from or received by a community, and processing said message topics for determining a similarity measure between said communities based on said topics.

3. The method for targeting message delivery as claimed in claim 2, wherein said determining attributes further comprises: determining an amount messaging activity taking place in a community.

4. The method for targeting message delivery as claimed in claim 3, wherein said graphical representation comprises an interconnection of nodes representing each community, an attribute of a node selected according to said determined amount of messaging activity taking place at that community, said nodes being interconnected according to a similarity measure.

5. The method for targeting message delivery as claimed in claim 4, wherein said interface provides a filter function for enabling manipulation of a set of communities displayed via said interface.

6. The method for targeting message delivery as claimed in claim 5, wherein said method further comprises: manipulating a filter function for enabling users to search for one or more of: community names, descriptions, and topics within each community by specifying keywords.

7. The method for targeting message delivery as claimed in claim 5, wherein said method further comprises: manipulating a filter function for enabling users to determine community similarities above a threshold similarity strength.

8. The method for targeting message delivery as claimed in claim 5, wherein said method further comprises: manipulating a filter function for enabling users to filter out communities based on the number of broadcast messages sent to them.

9. The method for targeting message delivery as claimed in claim 4, further comprising the step of: interacting with said graphical representation via said interface, and in response, generating a display area via said interface comprising information about interconnected nodes in the representation.

10. A system for targeting message delivery in a messaging system comprising:
means for monitoring attributes of messages associated with one or more communities of users communicating in a messaging system;
means for dynamically representing said attributes and their inter-relationships via an interface devices for an end-user;
means enabling an end-user to make a selection of a community based on the dynamic representation.

11. The system as claimed in claim 10, wherein said means for monitoring comprises a means for accessing message topics sent from or received by a community and further processing said message topics for determining similarities between said communities based on said topics.

12. The system as claimed in claim 11, wherein said means for processing of message topics comprises means for performing a similarity computation between all of the words in those topics to result in a similarity measure between the communities.

13. The system as claimed in claim 11, wherein said means for monitoring further comprises means for determining an amount messaging activity taking place in a community.

14. The system as claimed in claim 13, wherein said means for dynamically representing said attributes comprises means for generating a graphical representation via said end-user interface device, said graphical representation comprising: an interconnection of nodes representing each community, an attribute of a node selected according to said determined amount of messaging activity taking place at that community, said nodes being interconnected according to a similarity measure.

15. The system as claimed in claim 14, wherein said interface provides a filter function for enabling manipulation of a set of communities displayed via said interface.

16. The system as claimed in claim 14, further comprising: means enabling user interaction with said graphical representation via said interface, and means responsive to said user interaction for generating a display area via said interface comprising information about interconnected nodes in the representation.

17. A computer program product comprising a computer usable medium having a computer usable program code for targeting message delivery in a messaging system, said computer program product comprising:
computer readable program code for determining one or more attributes of messaging activity associated with one or more communities of users communicating in a messaging system;
computer readable program code for displaying via an interface, a graphical representation of said attributes and inter-relationships between said attributes; and,
computer readable program code for enabling a user to select via said interface a recipient community for receiving a message to be sent based on said graphical representation displayed.

18. The computer program product as claimed in claim 17, wherein said computer readable program code for determining one or more attributes comprises computer readable program code for: accessing message topics sent from or received by a community, and processing said message topics for determining a similarity measure between said communities based on said topics.

19. The computer program product as claimed in claim 18, wherein said computer readable program code for determining attributes further comprises: readable program code for determining an amount messaging activity taking place in a community.

20. The computer program product as claimed in claim 19, further comprising computer readable program code for displaying comprises computer readable program code for generating a graphical representation via said end-user interface device, said graphical representation comprising: an interconnection of nodes representing each community, an attribute of a node selected according to said determined amount of messaging activity taking place at that community, said nodes being interconnected according to a similarity measure.
